(19) United States
(12) Patent Application Publication
(10) Pub. No.: US 2005/0019489 A1
(43) Pub. Date: Jan. 27, 2005

(54) Method of producing waterproof foam mattresses

(76) Inventor: Benito Martinez Choperena, Orcoyen (ES)

Correspondence Address: NATH & ASSOCIATES, 1030 15th STREET, NW, 6TH FLOOR, WASHINGTON, DC, 20005, US

(21) Appl. No.: 10/489,340

(22) PCT Filed: Sep. 12, 2002
(86) PCT No.: PCT/ES02/00427

(30) Foreign Application Priority Data
Sep. 13, 2001 (ES) P200102059

(51) Int. Cl. B68G 7/00

(52) U.S. Cl. 427/244; 427/541; 427/346

(57) ABSTRACT

Production process for waterproofed foam mattresses, starting from a foam material body (1) in which a plurality of passing through holes (2) are carried out in the bigger faces and some passing through holes (3) with a smaller diameter are carried out along the body (1), through which holes (3) some rods (4) are incorporated to be fastened on a supporting frame (5), and to spray the body (1) in this position with the waterproofing material, letting the latter drip off in a sloped position till the mentioned waterproofing material is gelled.

The present invention refers to a production process for mattresses made up of a body of foam material with a waterproofing covering on the outer surface.

Mattresses made up of a foam rubber body are already known, either in an only piece or in layers joined in a sandwiched way; the foam material can be polyurethane, latex or a combination of these or other materials.

The practice of carrying out transverse openings in the foam rubber body of the mattresses is also known, to ease up the ventilation of the surface supporting the user, as for example according to the Spanish Utility Models 8902662, 9901047 and 200001179.

The incorporation of a waterproofing covering on the outer surface of the foam rubber body of the indicated mattresses is again known, according to the same mentioned Utility Models, so as to avoid the penetration of humidity in the same, either by the user's sweat or when it is cleaned.

According to the object of the present invention a process is proposed for the production of this kind of mattresses, by means of which a simple easy realization is reached, resulting moreover highly positive for the mentioned mattresses.

This process, object of the invention, starts from a foam body with the dimensions of the mattress to be made, perforating the mentioned body between the bigger faces with a plurality of passing holes, which are carried out with a hollow cylindrical drill, while at the side some holes with a smaller diameter are carried out in the foam body, through which some rods are passed to fix the foam body respect to a supporting frame, and in this disposition the foam body is sprayed with a mixture of latex, being situated after the supporting frame, with the foam body in an inclined position so as to drain off the excess of latex mixture and finally it is dried in an oven.

After the drying, the mattress body is taken off the supporting frame, and at the ends of the side holes some valves are glued, which are susceptible of being closed provisionally by means of blanking plugs.

This way a mattress is obtained which is perfectly waterproofed, for its use and with a realization which makes it very comfortable, as the passing through holes between the bigger faces make the foam body more fluffed up, easing up at the same time the ventilation of the surface supporting the user, while the side holes, which can be left uncovered when the mattress is used, cooperate in the comfort, easing up the evacuation of the air inside the foam body when the user leans on the mattress, while to clean the mattress, the mentioned side holes can be plugged up so that no water can penetrate inside the foam body.

The production process, on the other hand, is very simple, allowing the application of an exterior waterproofing covering on the foam body without having to touch the latter at all during the process.

In view of all this, the mentioned process, object of the invention certainly has some very advantageous features, acquiring own life and preferable character in its application.

FIG. 1 shows a foam body in perspective for the process of the invention.

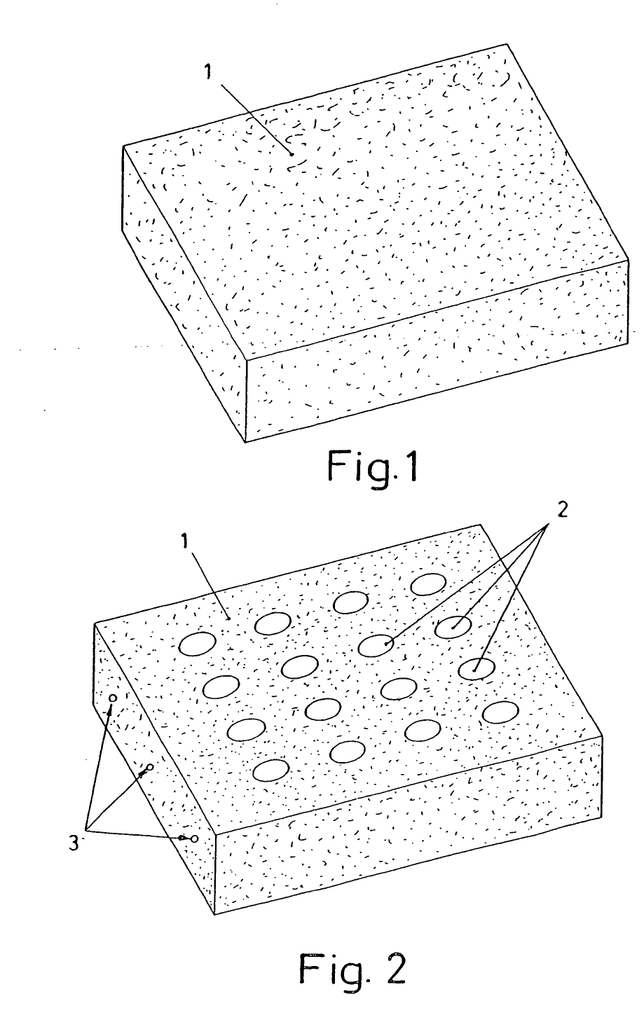

FIG. 2 is a perspective of the foam body after carrying out the transverse and side holes in it.

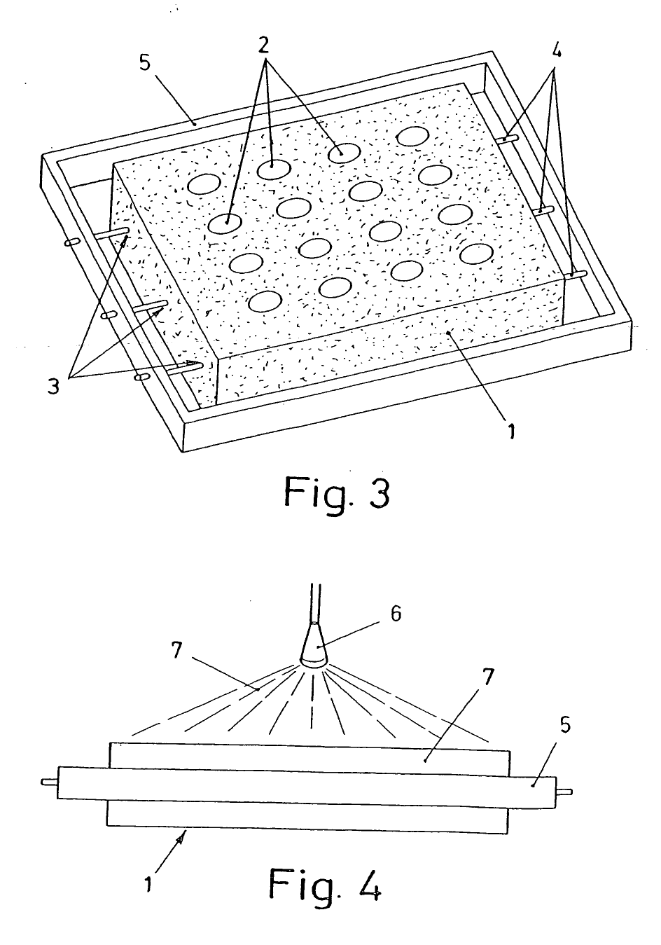

FIG. 3 represents a perspective of the foam body disposition on the supporting frame to apply the waterproofing covering.

FIG. 4 is a side view showing in a schematic way the application of the waterproofing covering on the foam body.

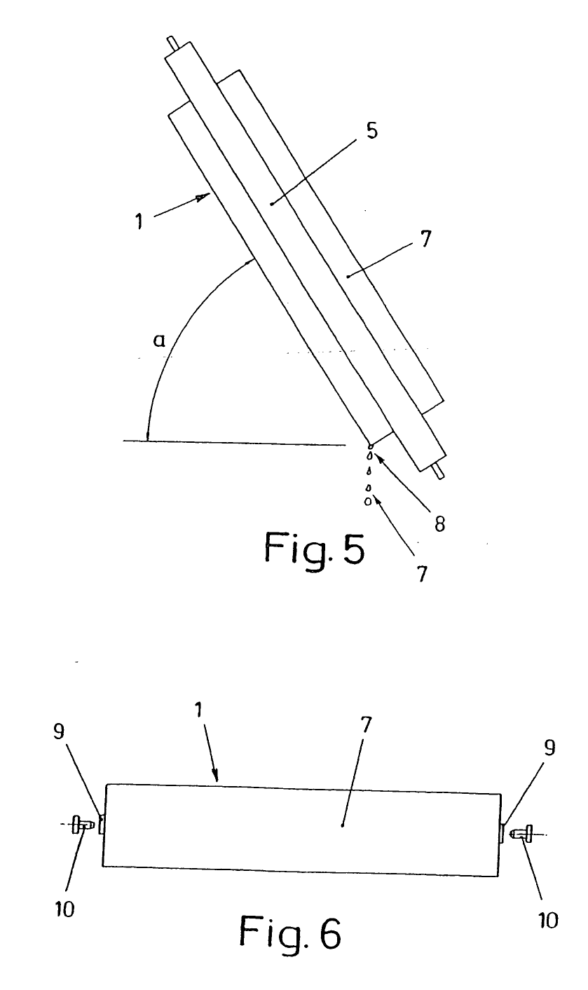

FIG. 5 is a side view of the disposition for the draining off of the waterproofing applied on the foam body.

FIG. 6 is a side view of the mattress body in the final disposition with the valves incorporated at the ends of the side holes.

The object of the invention refers to a production process for mattresses made up of a foam material body, foreseen of ventilation holes and with a waterproofing covering on the outer surface.

The process is developed starting from a foam material body (1), with the dimensions of the mattress to be produced, the mentioned body (1) can be an only piece or it can be made up of layers joined in a sandwiched way, while the material can be any susceptible of foaming used for this kind of objects, such as latex, polyurethane, etc . . . or combinations of the mentioned products.

Some passing through holes (2) are carried out in the mentioned body (1) between the bigger faces, the mentioned holes are made by means of a hollow cylindrical drill. The distribution and the number and diameter of these holes (2) can vary according to the mattress to achieve.

Through the mentioned body (1) some side holes (3) are moreover carried out, which pass it from side to side, and which are carried out in the same way as the holes (2), but with a smaller diameter.

The number of the mentioned side holes can also vary, there can, for example, be three or four of them, and their function is to introduce some rods (4) through them, these rods can be made of stainless steel for instance, to fasten the body (1) respect to a supporting frame (5), in the way represented on FIG. 3.

In this disposition, the body (1) can be manipulated without the need to touch it, to spray a waterproofing product (7) on it, by means of a projector (6).

The product (7) of waterproofing material that is used for this end is a mixture of latex, made up of 100% natural and/or artificial latex, vulcanizing pasta, thickener, antioxidant, bactericide, titanium, wax and colouring agent; carrying out the mentioned mixture for the application with a viscosity of 45-50 seconds per quarter, preferably around 45 seconds per quarter. A proportion of 87% of latex, 6% of vulcanizing pasta, 6% of thickening agent, 0.5% of titanium, 0.25% of bactericide and 0.25% of colouring agent.

The application of the mentioned waterproofing mixture (7) is carried out with an air pump under pressure of 3-4 kilos, preferably around 4 kilos but without exceeding the mentioned pressure, so to avoid the mixture (7) to penetrate in the foaming material of the body (1). The mentioned application is carried out from a height of 15-20 centimeters, preferably around 20 centimeters but without exceeding the mentioned height, also to avoid the penetration of the mixture (7) in the foam material of the body (1).

Once the waterproofing mixture (7) has been applied, the sprayed body (1) is situated, by means of the supporting frame (5), in an inclined position in the way shown on FIG. 5, in which the applied mixture (7) drains off, perfectly covering the surface of the body (1) and dripping off the excess.

The sloping angle (a) for the draining is 57-60°, having verified that the ideal angle for a preferable viscosity of 45 seconds per quarter is 57°, at which the applied mixture (7) flows in a fluid way along the surface of the body (1) without accumulating anywhere, remaining only drops (8) at the lower edges, and which are easy to take away manually afterwards.

The draining phase is maintained for 6-7 hours, time during which the pre-drying of the waterproofing mixture (7) is carried out, resulting the latter gelled.

After this draining and pre-drying period, a drying in oven at a temperature of 80-120° C., preferably around 80° C., is carried out in an environment with continuous dry hot air current.

Once the mixture (7) applied on the body (1) is dry, the latter is dismounted from the supporting frame (5), taking away the rods (4), with which the side holes (3) remain free.

When the mattress is finished off, respect to the ends of the mentioned side holes (3), some valves (9) are glued in, which allow their closure by means of the corresponding plugs (10), in such a way that the mentioned plugs (10) are taken away when the mattress is used, so that the air can flow out freely from inside the body (1) when the user leans on it, making its use more comfortable, while when the mattress is cleaned, the plugs (10) can be put in so as to avoid the entrance of water inside the foam body (1).

The production process, according to what is described, which correspond to the object of the invention, can in any case be used applicable for mattresses for beds of any size, as well as for pillows, cushions or any other element whose end is to ease up the user's commodity by means of a fluffed up support.

1. Production process for waterproofed foam mattresses, of the kind made up of a foam material body, which has ventilation holes and a waterproofing covering, characterized in that a foam material body (1) is started from, this body has the size of the mattress to be made, in which a plurality of passing through holes (2) are carried out with a hollow cylindrical drill between the bigger faces, while sideways, crossing the body (1) some holes (3) with a smaller diameter are drilled, through which some rods (4) are passed which are to be fixed on the manoeuvring supporting frame (5), carrying out in this disposition a spraying of the body (1) with a waterproofing material (7), which is let to drip off afterwards in an inclined position till the material (7) is gelled, after which a final drying is reached in an oven.

2. Production process for waterproofed foam mattresses, according to the first claim, characterized in that the waterproofing material (7) is a mixture of 100% natural and/or artificial latex, vulcanizing pasta, thickener, antioxidant, bactericide, titanium, wax and colouring agent, being carried out the mentioned mixture for the application with a viscosity of 45-50 seconds per quarter, preferably around 45 seconds per quarter.

3. Production process for waterproofed foam mattresses, according to the first claim, characterized in that the waterproofing material (7) application is carried out at a pressure of 3-4 kilos, preferably around 4 kilos, without exceeding this pressure, and from a height of 15-20 centimeters, preferably around 20 centimeters, without surpassing this height.

4. Production process for waterproofed foam mattresses, according to the first claim, characterized in that the draining angle (a) of the waterproofing material (7), after its application, is of 57-60°, preferably an angle of 57°, maintaining this position for a time of 6-7 hours so that the material (7) is allowed to gel.

5. Production process for waterproofed foam mattresses, according to the first claim, characterized in that the final drying in an oven is carried out at a temperature of 80-120° C., preferably around 80° C., in an environment with continuous dry hot air current.

6. Production process for waterproofed foam mattresses, according to the first claim, characterized in that after the final drying of the body (1) covered with the waterproofing material (7) the supporting frame (5) is dismounted, incorporating at the ends of the side holes (3) by means of gluing, some valves (9) which can be closed provisionally by means of withdrawable plugs (10).
